(19) United States
(12) Patent Application Publication
(10) Pub. No.: US 2011/0000184 A1
(43) Pub. Date: Jan. 6, 2011

(54) Method to protect jet engines from bird strikes

(76) Inventor: Benton Frederick Baugh, Houston, TX (US)

Correspondence Address: BENTON F. BAUGH, 19210 Cohen Green Lane, HOUSTON, TX, 77094, US

(21) Appl. No.: 12/459,593

(22) Filed: Jul. 6, 2009

(51) Int. Cl. F02G 3/00

(52) U.S. Cl. 60/39.092

(57) ABSTRACT

The method of preventing the dangers of birds entering the jet engines of an airplane during take-off and landing by rotating a portion of the jet engines cowling to a blocking position in front of the jet engine during take-off and landing and the rotating the same portion of the jet engine cowling back away from the front of the jet engine during high speed cruising at altitudes.

### CROSS-REFERENCE TO RELATED APPLICATIONS

N/A

### STATEMENT REGARDING FEDERALLY SPONSORED RESEARCH OR DEVELOPMENT

N/A

### INCORPORATION-BY-REFERENCE OF MATERIAL SUBMITTED ON A COMPACT DISK

N/A

### BACKGROUND OF THE INVENTION

The field of this invention of that of the safety of jet engine air planes and the passengers on board when the jet engines are shut down due to the ingesting of birds with the potential of catastrophic engine failure with the possibility of the plane crashing.

There have more than 100,000 bird strikes since 1990 according to the FM with 11 people dying. Recently a plane with probably 200 people went down in the Hudson River in New York. If the pilot had not been so lucky as to have landed in the river, the plane would have hit the buildings in New York, killing the 200 passengers plus potentially many more on the ground.

Jet engines are designed to ingest a bird and not stop running. The problem happens when the plane hits a flock of birds and numerous birds enter the engine at the same time and causing the engine to shut down. The problem will be worse near the ground when a flock of birds is scared into the air and the pilot does not have time to react and take evasive actions.

### BRIEF SUMMARY OF THE INVENTION

The object of this invention is to provide a method of preventing birds from entering the engine of a jet plane during take off and landing.

A second object of the present invention is to provide a method of preventing birds from entering the engine of a jet plane in such a way that the fuel efficiency of the plane is not compromised at cruising altitudes.

### BRIEF DESCRIPTION OF SEVERAL VIEWS OF THE DRAWINGS

FIG. 1 is 3 orthographic views and one perspective view of a plane with the rotary style embodiment of this invention in the low altitude, low speed mode.

FIG. 2 is 3 orthographic views and one perspective view of a plane with the rotary style embodiment of this invention in the high altitude, high speed cruise mode.

FIG. 3 is a section view of the jet engine using a rotary style embodiment of the present invention in the high altitude, high speed cruise mode.

FIG. 4 is a section view of the jet engine using a rotary style embodiment of the present invention in the low altitude, low speed mode.

FIG. 5 is 3 orthographic views and one perspective view of a plane with the telescopic style embodiment of this invention in the low altitude, low speed mode.

FIG. 6 is 3 orthographic views and one perspective view of a plane with the telescopic style embodiment of this invention in the high altitude, high speed cruise mode.

FIG. 7 is a section view of the jet engine using a telescopic style embodiment of the present invention in the high altitude, high speed cruise mode.

FIG. 8 is a section view of the jet engine using a telescopic style embodiment of the present invention in the low altitude, low speed mode.

### DETAILED DESCRIPTION OF THE INVENTION

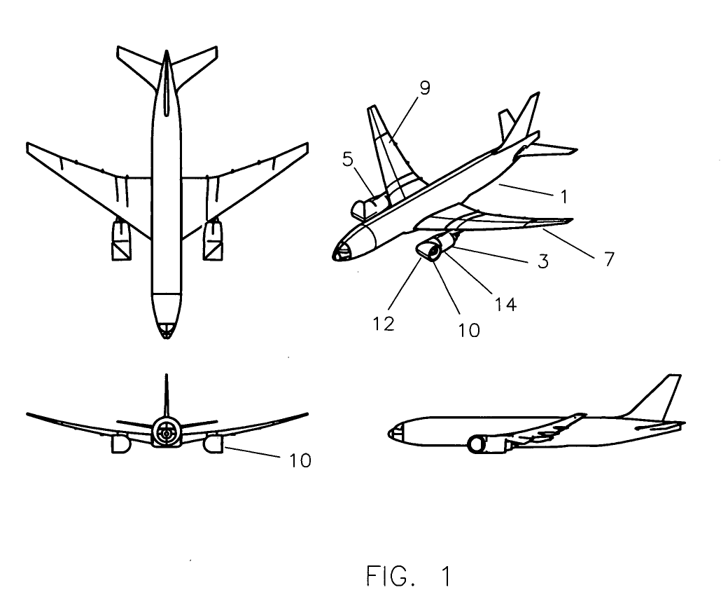

FIG. 1 shows a jet plane 1 with jet engines 3 and 5 mounted on wings 7 and 9 respectively. Inlet 10 of jet engine 3 is shown to be pointing directly to the side. Surface 12 which faces the front of the plane and which will be impacted by birds is shown to be a generally cylindrical area, of approximately the same radius as the outer diameter 14 of the jet engine.

This means that in this configuration, all of the air coming into the jet engine 3 is coming from the side rather than from the front, and that a bird coming from the front will not enter the jet engine 3. This configuration eliminates the ram jet effect of the jet engine which is a benefit at high speeds. This will impact the performance of the jet engine, but as jet engines run on the runway before taking off it obviously does not stop the engines from accelerating the plane. If it is preferred, instead of the inlet to the jet engine from being at ninety degrees from the direction of travel, an angle of only eighty five or eighty degrees can be selected. At these angles, some ram jet benefit can be seen from the air coming into the engine and can limit the number of birds entering the engine rather than completely preventing it.

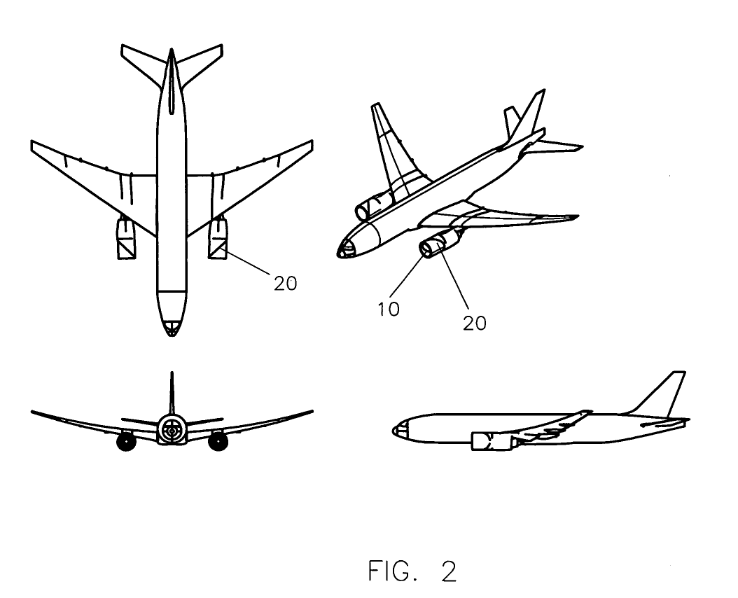

Referring now to FIG. 2, the jet plane 1 of FIG. 1 is shown with the inlet to the engine pointing straight toward the front. If this configuration is assumed after the low speed and low altitude take-off, the engine will see the full ram jet benefit of incoming air and the efficiency of the jet engine will not be compromised at cruising altitudes. Literally for all practical purposes, the jet engine has been changed to being a standard jet engine by rotation about the interface plane indicated as 20 which will be discussed in the following figures.

Referring now to FIG. 3, a jet engine 3 is shown with the adaptations of the present invention including the interface plane 20 and showing inlet 24 and surface 26. Jet engine fan blades 30 are shown within the cowling 32. The cowling 32 is divided into the fixed portion 34 which is fixed to the airplane wing and the rotary portion 36. At the interface 20 between the fixed portion 34 and the rotary portion 36 are bearings 38 and gear 40. Gear 40 is engaged by a small gear 42 which in turn is mounted on the drive motor 44 which is in turn is mounted on cowling fixed portion 34. Drive motor 44 has a rotary encoder 46 which can be used to control and set the number of motor rotations to move the rotary portion 36 from the blocking (side inlet) to the non-blocking (front inlet) positions.

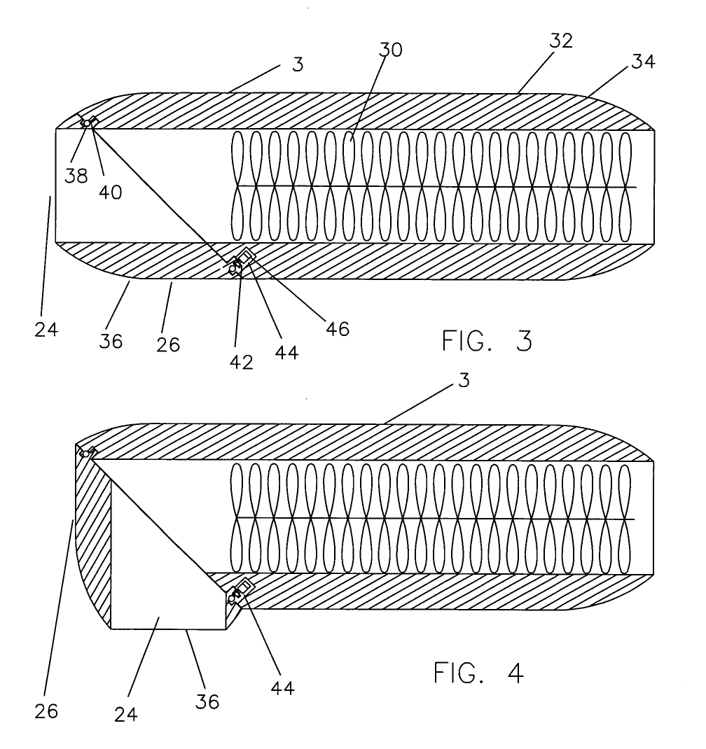

Referring now to FIG. 4, the drive motor 44 has rotated the rotary portion 36 approximately 180 degrees to move surface 26 to a position blocking the air passage where inlet 24 was in FIG. 3, and has moved the inlet 24 to the side generally where surface 26 was in FIG. 3. In this condition as the jet engine moves forward (to the left in the FIG. 4) birds will be blocked from entering the inlet 24 of the jet engine 3.

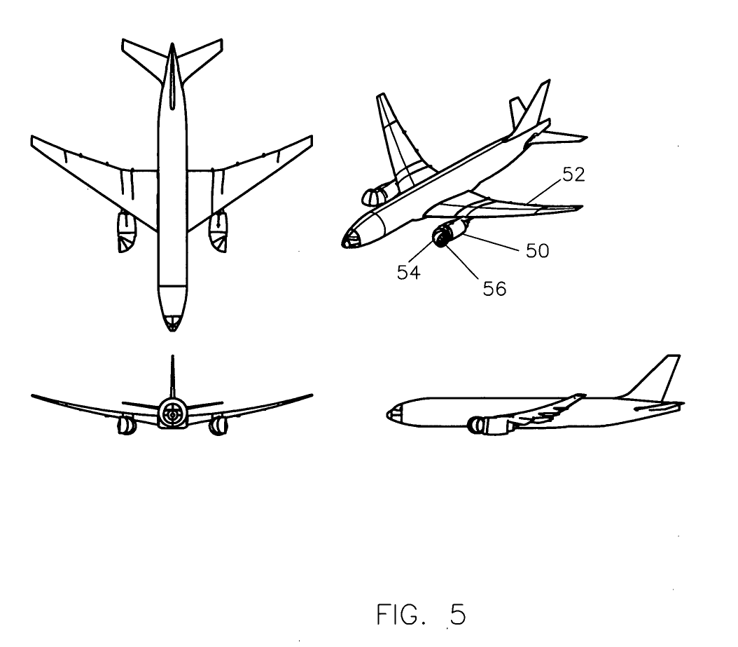

Referring now to FIG. 5, another embodiment of this invention is shown. The jet engine 50 on airplane 52 is configured to block air from entry at from the front 54. Inlet 56 is shown facing to the side rather than the front.

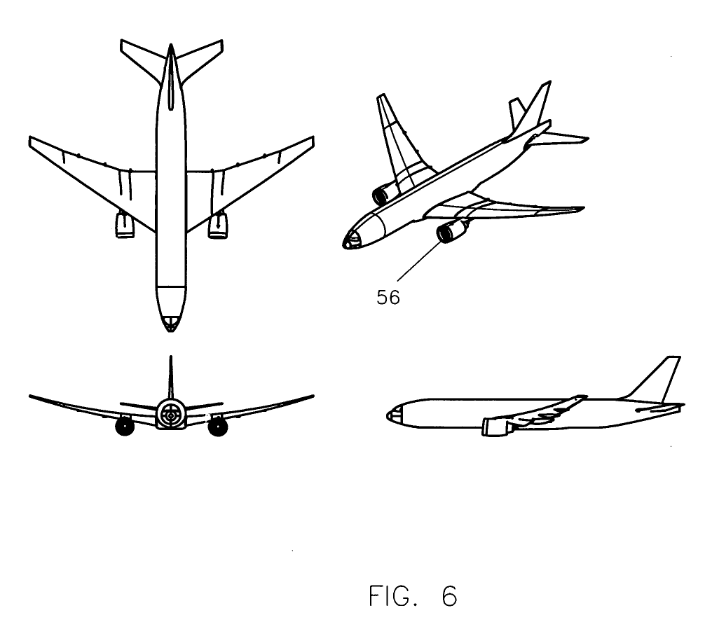

Referring now to FIG. 6, the air engine is in the configuration for high speed cruising rather than takeoff. This figure is similar to FIG. 2, except the rotational plane 20 is not seen.

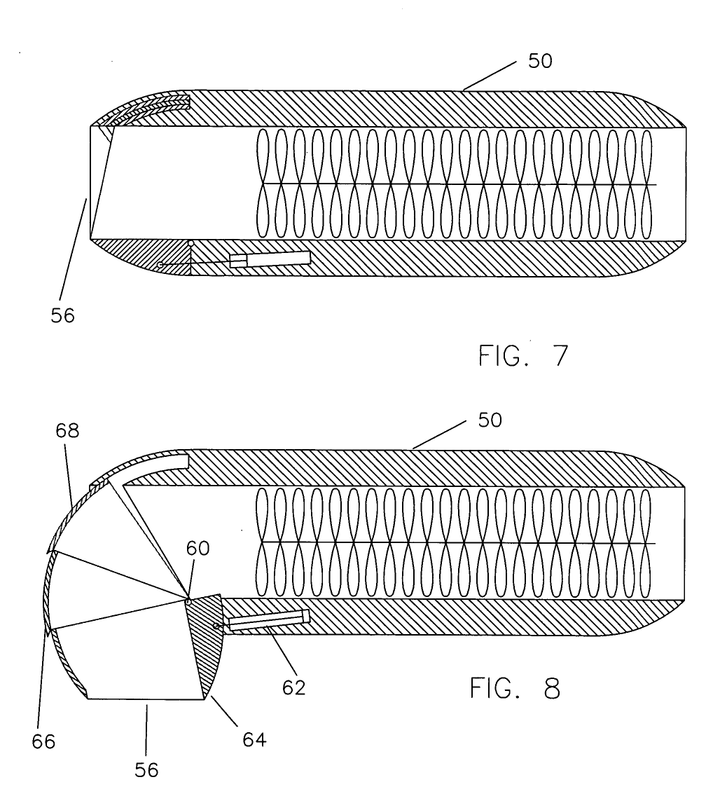

Referring now to FIG. 7, the jet engine 50 of FIGS. 5 and 6 is shown with inlet 56 facing forward.

Referring now to FIG. 8, the jet engine 50 is shown with the inlet 50 rotated ninety degrees about pivot axle 60 such that it is pointing to the side. Hydraulic cylinder 62 provides the motive force to move the front cowling section 64 about ninety degrees to the side with interconnecting sections 66 and 68 brought along in a sort of telescoping fashion.

The embodiment of FIGS. 1 thru 4 present a blocking cylindrical surface to the front. The embodiment of FIGS. 5 thru 8 presents a mostly spherical surface to the front, presenting less air speed drag than the cylindrical surface of the embodiment of FIGS. 1 thru 4.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of preventing birds from entering the intake of a jet engine having a central axis on an airplane, comprising
blocking the air and birds from entering said jet engine from in front of said jet engine with a blocking surface and causing the air entering said jet engine to enter from the side of said jet engine.

2. The invention of claim 1, further comprising rotating said blocking surface to a position which does not block air from entering said jet engine from the front of said jet engine when said blocking is not desired.

3. The invention of claim 2, further comprising said rotating of said blocking surface is accomplished by rotating said blocking surface about an axis which is at an angle relative to the said central axis thru said jet engine.

4. The invention of claim 3, further comprising providing an electric motor driving a gear to power the rotation.

5. The invention of claim 2, further comprising providing a rotary encoder to determine the rotary position of said blocking surface.

6. The invention of claim 2, further comprising said rotating of said blocking surface is accomplished by rotating said blocking surface about an axis which is skewed relative to the said central axis thru said jet engine.

7. The invention of claim 6, further comprising said blocking surface is a multiplicity of sections which telescope together.

8. The invention of claim 6, further comprising said blocking surface is rotated by a hydraulic cylinder.

9. A method of preventing birds from entering the intake of a jet engine having a central axis on an airplane, comprising
blocking the air and birds from entering said jet engine from in front of said jet engine with a blocking surface and causing the air entering said jet engine to enter other than from in front of said jet engine.

10. The invention of claim 9, further comprising rotating said blocking surface to a position which does not block air from entering said jet engine from the front of said jet engine when said blocking is not desired.

11. The invention of claim 10, further comprising said rotating of said blocking surface is accomplished by rotating said blocking surface about an axis which is at an angle relative to the said central axis thru said jet engine.

12. The invention of claim 11, further comprising providing an electric motor driving a gear to power the rotation.

13. The invention of claim 10, further comprising providing a rotary encoder to determine the rotary position of said blocking surface.

14. The invention of claim 10, further comprising said rotating of said blocking surface is accomplished by rotating said blocking surface about an axis which is skewed relative to the said central axis thru said jet engine.

15. The invention of claim 14, further comprising said blocking surface is a multiplicity of sections which telescope together.

16. The invention of claim 14, further comprising said blocking surface is rotated by a hydraulic cylinder.
